(19) United States
(12) Patent Application Publication
(10) Pub. No.: US 2011/0080486 A1
(43) Pub. Date: Apr. 7, 2011

(54) INFORMATION PROCESSING APPARATUS AND DATA TRANSMISSION METHOD

(75) Inventor: Tatsuo YAMAGUCHI, Kunitachi-shi (JP)

(73) Assignee: KABUSHIKI KAISHA TOSHIBA, Tokyo (JP)

(21) Appl. No.: 12/896,769

(22) Filed: Oct. 1, 2010

(30) Foreign Application Priority Data
Oct. 1, 2009 (JP) 2009-229733

(51) Int. Cl. H04N 5/225

(52) U.S. Cl. 348/207.1; 348/E05.024

(57) ABSTRACT

According to one embodiment, an information processing apparatus includes a communication module, an input module, a capturing module, a storing module, a path register module, and a transmission module. The communication module is configured to make a close-proximity wireless transfer. The capturing module is configured to capture an image displayed on a screen of a display according to an input from the input module. The storing module is configured to store an image file corresponding to the captured image in a storage. The path register module is configured to register, in a transmission tray, path data indicating a path of the image file stored in the storage. The transmission module is configured to transmit the image file indicated by the path data registered in the transmission tray to an external device by the close-proximity wireless transfer when a connection is established between the communication module and the external device.

### CROSS-REFERENCE TO RELATED APPLICATIONS

This application is based upon and claims the benefit of priority from Japanese Patent Application No. 2009-229733, filed Oct. 1, 2009; the entire contents of which are incorporated herein by reference.

### FIELD

Embodiments described herein relate generally to a data transmission method to an information processing apparatus configured to make close-proximity wireless transfer.

### BACKGROUND

In recent years, wireless communication such as near field communication (NFC) has been used. As such wireless communication becomes popular, a user can easily make communication for authentication and accounting simply by placing an IC card or a cell-phone over a reader/writer of a host processor.

Further, a new, faster close-proximity wireless transfer technique has recently been developed. The new close-proximity wireless transfer technique enables transfer of document, image, and audio data files between devices, as well as authentication and accounting services, simply by approaching the devices towards each other.

Jpn. Pat. Appln. KOKAI Publication No. 2005-332160 discloses a cell-phone having a function of browsing Web pages, saving desired image data, and sending data attached to e-mail.

Nowadays, the Internet is widely used, and a user can get various information from Web pages by using a browser (browsing software). Therefore, if image data can be transferred from one device to another, together with a display screen of that image data, the user convenience is increased. For example, a map to a destination can be taken into a cell-phone as image data, simply by approaching a cell-phone to a personal computer displaying a Web page showing the map.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary external view of an information processing apparatus according to an embodiment.

FIG. 2 illustrates close-proximity wireless transfer between a cell-phone and an information processing apparatus.

FIG. 3 is an exemplary block diagram of a system configuration of the information processing apparatus shown in FIG. 1.

FIG. 4A and FIG. 4B show exemplary gadgets displayed on an LCD by a close-proximity wireless transfer gadget application program.

FIG. 5 shows exemplary block diagrams of an operating system, an authentication application program, and a transmission tray application program.

FIG. 6 is an exemplary window displayed on an LCD by a transmission tray startup module.

FIG. 7 is an exemplary window displayed on an LCD by a transmission control module during transmission of an image file.

FIG. 8 is an exemplary window displayed on an LCD by a transmission application program, when communication with an external device is impossible.

FIG. 9 is an exemplary window displayed on an LCD by a transmission tray application program, when the transmission tray button shown in FIG. 4A is pressed.

FIG. 10 is an exemplary flowchart of processing executed by a transmission tray application program.

FIG. 11 is an exemplary window displayed by a device management module, for asking a user whether to register an external device for which a connection is established, as a device permitted to make communication.

FIG. 12 is an exemplary flowchart of processing executed by a communication control driver and an authentication application program.

### DETAILED DESCRIPTION

Various embodiments will be described hereinafter with reference to the accompanying drawings.

In general, according to one embodiment, an information processing apparatus comprises a communication module, an input module, a capturing module, a storing module, a path register module, and a transmission module. The communication module is configured to make a close-proximity wireless transfer. The capturing module is configured to capture an image displayed on a screen of a display according to an input from the input module. The storing module is configured to store an image file corresponding to the captured image in a storage. The path register module is configured to register, in a transmission tray, path data indicating a path of the image file stored in the storage. The transmission module is configured to transmit the image file indicated by the path data registered in the transmission tray to an external device by the close-proximity wireless transfer when a connection is established between the communication module and the external device.

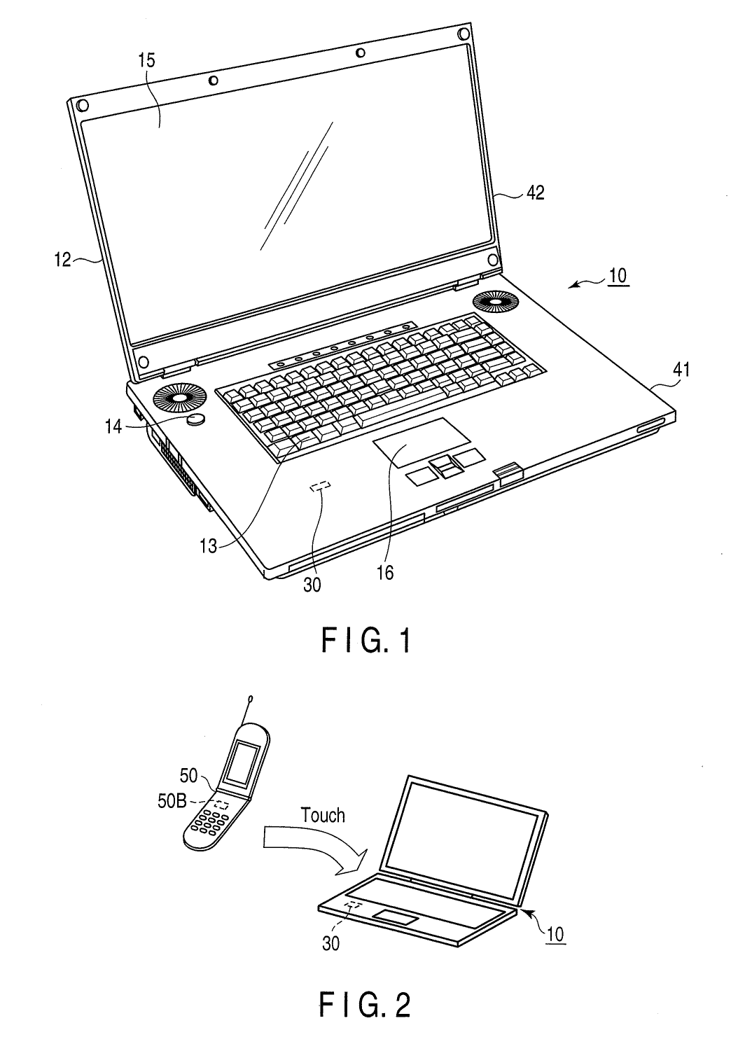

FIG. 1 is a perspective external view of an information processing apparatus according to an embodiment. As shown in FIG. 1, the information processing apparatus is realized as a battery-powered portable personal computer 10, or a notebook computer.

The computer 10 comprises a main unit 41, and a display unit 42. The display unit 42 is pivotally fixed to the main unit 41 to be movable between an opened position exposing the top face of the main unit 41 and a closed position covering the top face of the main unit 41 by the display unit 42. The display unit 42 is provided with an LCD 15.

The main unit 41 is housed in a thin box-shaped case. On the top face of the case of the main unit 41, a keyboard 13, a touch pad 16, and a power switch 14 are provided.

The computer 10 contains a close-proximity wireless transfer device. The close-proximity wireless transfer device is a communication module for executing close-proximity wireless transfer. The close-proximity wireless transfer device establishes a wireless connection for a device (an external device) having a close-proximity wireless transfer function, existing within a certain distance, and transmits data as a file to the device. Close-proximity wireless transfer between the close-proximity wireless transfer device and external device is executed in a peer-to-peer fashion. A communicable distance is 3 cm, for example. Wireless connection between the close-proximity wireless transfer device and external device is possible only when an external device is within the communicable distance (e.g., 3 cm) to the close-proximity wireless transfer device. When an external device is within the communicable distance to the close-proximity wireless transfer device, a connection is established between the devices, and data as a file explicitly specified by a user, or a previously synchronized data file is transferred between the close-proximity wireless transfer device and external device.

An induced electric field is used in close-proximity wireless transfer. Transfer JET can be used as a method of close-proximity wireless transfer. Transfer JET uses an ultra wide band (UWB), and realizes high-speed data transfer.

The top face of the main unit 41, specifically, a part of a palm rest area, functions as a transmitting face. In other words, a close-proximity wireless transfer device and antenna (coupler) 30 is embedded in the main unit 41, facing towards the top face. The antenna 30 is positioned to send a wireless signal (an induced electric field) to the outside through the top face of the main unit 41 (specifically, a part of the palm rest area on the top face of the main unit 41). A small area on the top face of the main unit 41 opposed to the antenna 30, or a small area above the antenna 30 on the top face of the main unit 41, is used as a communicating position. The close-proximity wireless transfer device makes close-proximity wireless transfer with an external device existing within a predetermined communicable distance (e.g., 3 cm) to the communicating position on the top face of the main unit 41, through the top face of the main unit 41.

A user can start data transfer between the computer 10 and external device by placing (touching) an external device having a close-proximity wireless transfer function over the communicating position on the top face of the main unit 41, for example.

FIG. 2 illustrates close-proximity wireless transfer between the computer 10 and cell-phone 50. In the cell-phone 50, an antenna (coupler) for close-proximity wireless transfer is embedded, facing to the backside. In this case, data can be transferred between the cell-phone 50 and computer 10 by placing the backside of the cell-phone 50 over the communicating position on the top face of the main unit 41 of the computer 20.

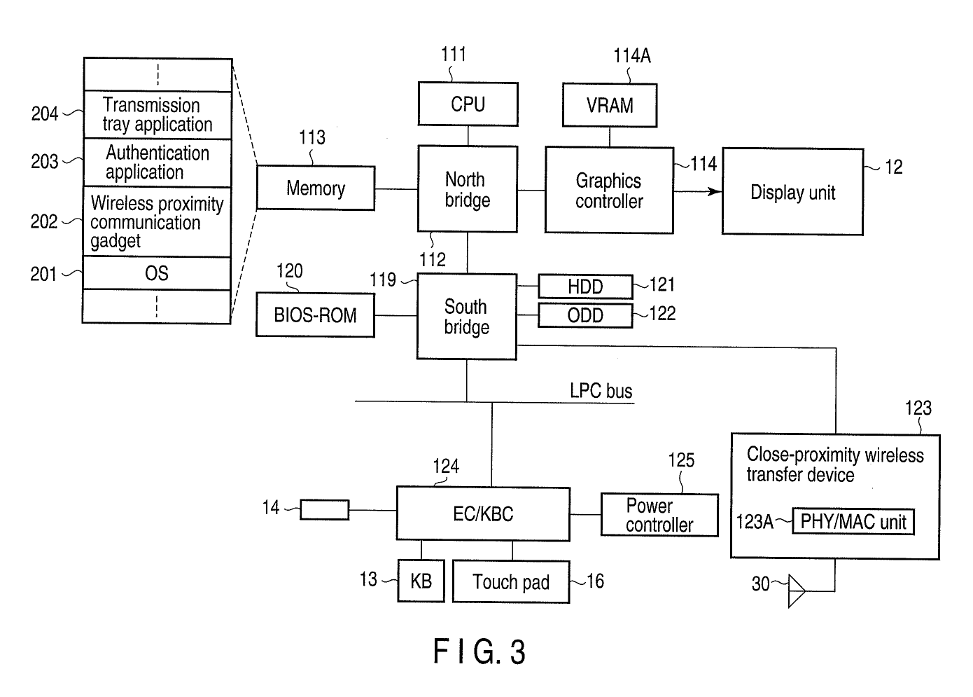

Next, a system configuration of the computer will be explained with reference to FIG. 3. FIG. 3 is a block diagram of a system configuration of the computer.

As shown in FIG. 2, the computer comprises a display unit 12, a CPU 111, a north bridge 112, a main memory 113, a graphics controller 114, a south bridge 119, a BIOS (Basic Input/Output System)-ROM 120, a hard disc drive (HDD) 121, an optical disc drive (ODD) 122, a close-proximity wireless transfer device 123, an embedded controller/keyboard controller IC 124, and a power supply controller 125.

The hard disc drive 121 stores codes for executing various programs such as an operating system (OS) and BIOS update program.

The CPU 111 is a processor to control operations of the computer, and executes various application programs, comprising an operating system 201, a close-proximity wireless transfer gadget application program 202, an authentication application program 203, and a transmission tray application program 204, which are loaded from the hard disc drive 121 into the main memory 113.

The CPU 111 executes a BIOS program stored in the BIOS-ROM 120. A BIOS program controls hardware.

The north bridge 112 connects a local bus of CPU 111 to south bridge 119. The north bridge 112 comprises a memory controller to control access to the main memory 113. The north bridge 112 has a function of communicating with the graphics controller 114 through an AGP bus.

The graphics controller 114 controls the LCD 15 used as a display monitor of the computer. The graphics controller 114 has a video memory 114A, and generates a video signal forming a display image to be displayed on the LCD 15 of the display unit 12, from the display data written in the video memory 114A by an OS/application program.

The south bridge controls devices on an LPC bus. The south bridge 119 comprises an ATA controller to control the HDD 121. The south bridge 119 has a function of controlling access to the BIOS-ROM 120.

The embedded controller/keyboard controller IC (EC/KBC) 124 is a one-chip microcomputer incorporated with an embedded controller to control power, and a keyboard controller to control the keyboard (KB) 13 and touch pad 16. The embedded controller/keyboard controller IC (EC/KBC) 124 has a function of turning on/off the computer 10 in response to the user's operation of the power switch 14.

The close-proximity wireless transfer device 123 comprises a PHY/MAC unit 123A, and an antenna 30. The PHY/MAC unit 123A is operated under the control of the communication control driver executed by the CPU 111. The PHY/MAC unit 123A communicates with an external device through the antenna 30. The antenna 30 is an electrode called a coupler, and is used for data transmission/reception to/from an external device. When an external device is within a communicable distance (e.g., 3 cm) to the antenna 30, the antennas (couplers) of the close-proximity wireless transfer device 123 and external device are connected by an induced electric field, and wireless communication is possible between the close-proximity wireless transfer device 123 and external device. The close-proximity wireless transfer device 123 and antenna 30 can be realized as one module.

A peripheral component interconnect (PCI) bus is used for data transfer between the close-proximity wireless transfer device 123 and south bridge 119. PCI express may be used instead of the PCI.

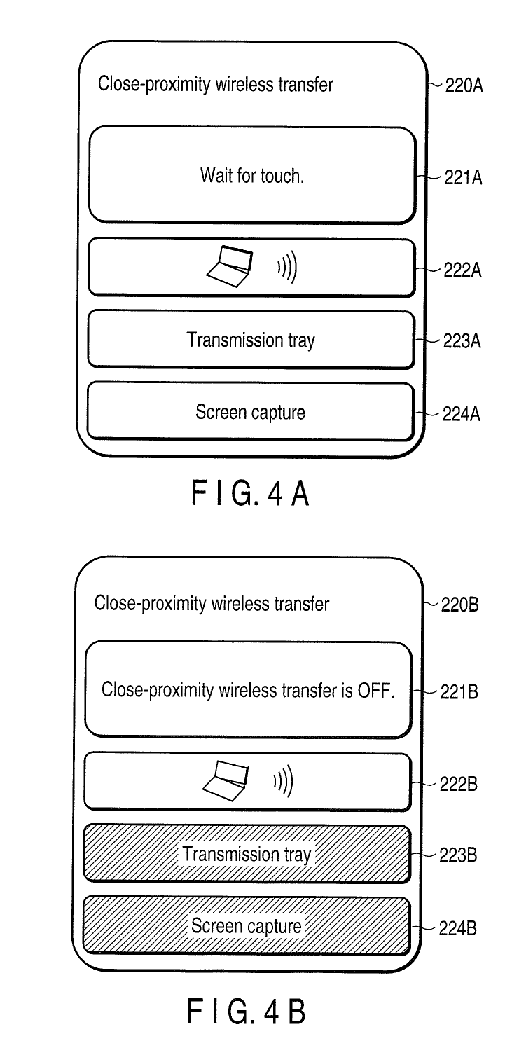

Next, the close-proximity wireless transfer gadget application program 202 will be explained. The close-proximity wireless transfer gadget 202 is a utility for using close-proximity wireless transfer. FIGS. 4A and 4B are windows displayed on the screen of the LCD 15 by the close-proximity wireless transfer gadget 202. The gadget 220A shown in FIG. 4A indicates that wireless proximity communication is being turned on, and the gadget 220B shown in FIG. 4B indicates that wireless proximity communication is being turned off.

Areas 221A and 221B indicate states of wireless proximity communication. The area 221A displaying “Wait for touch” indicates waiting for touch by an external device having a function of wireless proximity communication. The area 221B displaying “Wireless proximity communication is OFF” indicates that wireless proximity communication is turned off.

Switch buttons 222A and 222B are used to turn on and off wireless proximity communication. Each time the button 222A or 222B is pressed, wireless proximity communication is turned on or off. The illustrations of the buttons 222A and 222B indicate ON and OFF of wireless proximity communication, respectively. The illustration of the button 222A indicates that wireless proximity communication is ON. The illustration of the button 222B indicates that wireless proximity communication is OFF.

The transmission tray button 223A is used to start the transmission tray application program 204. In FIG. 4B, wireless proximity communication is being turned off, and the transmission tray button 223B is grayed out, indicating that the transmission tray application program 204 cannot be started.

The screen capture button 224A is used to transmit an image file storing an image displayed in the LCD 15 to an external device having a function of wireless proximity communication. In FIG. 4B, the screen capture button 224B is grayed out, indicating that a capture image cannot be transmitted.

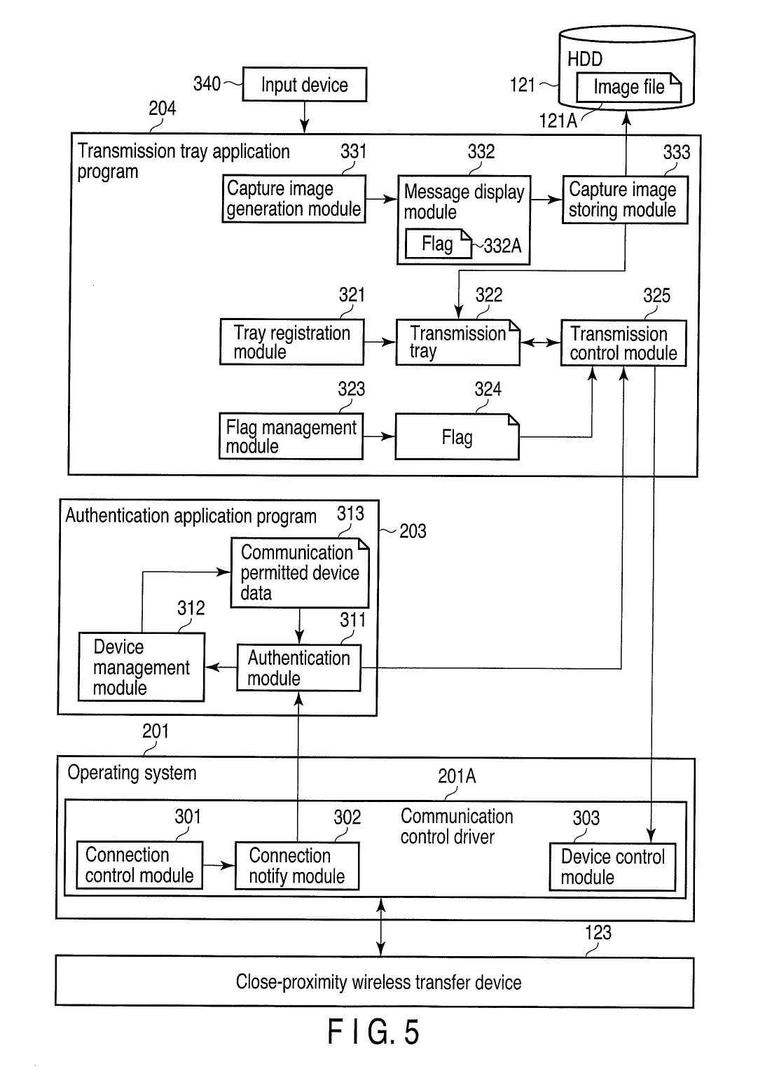

Next, an explanation will be given of the configurations of the operating system 201, authentication application program 203, and transmission tray application program 204, by referring to FIG. 5.

The transmission tray application program 204 comprises a transmission tray register module 321, a transmission tray 322, a flag management module 323, a flag 324, a transmission control module 325, a capture image generation module 331, a message display module 332, and a transmission tray start module 333.

When the user operates an input device 340, and the data indicating that the screen capture button 224A is pressed is entered, the wireless proximity communication gadget application program 202 specifies an option (−c), and starts the transmission tray application program 204.

The capture image generation module 331 of the transmission tray application program 204 captures an image displayed on the screen of LCD 15, and generates image data corresponding to the captured image. The image data is generated in the memory 113, for example.

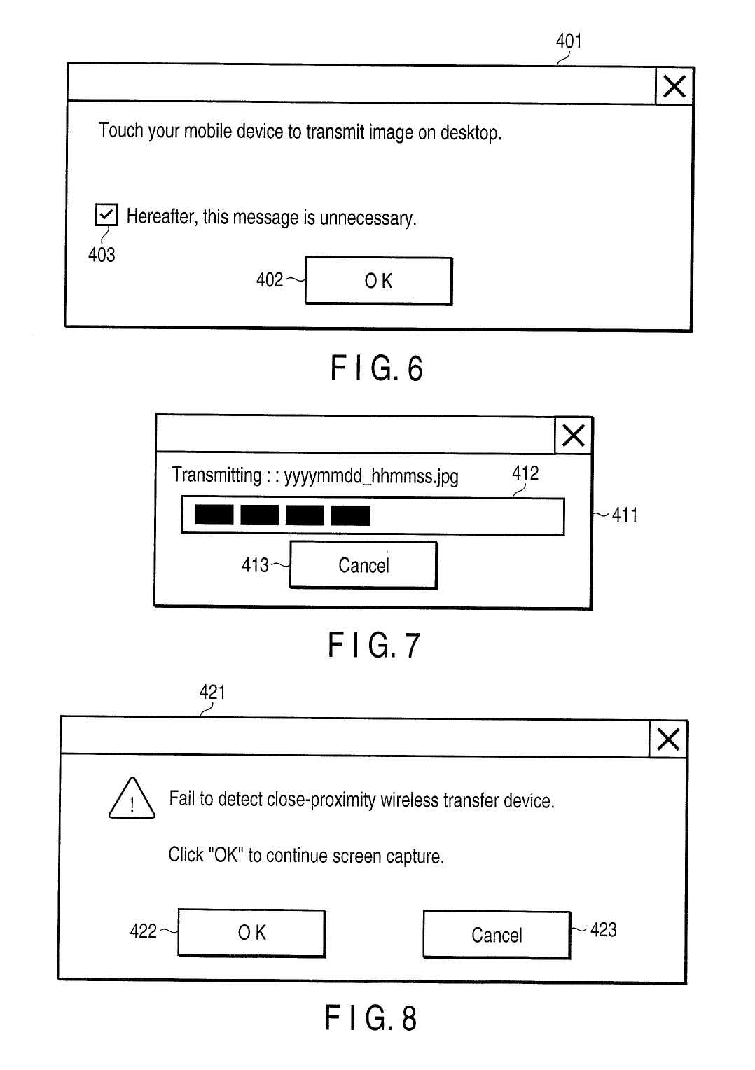

The message display module 332 displays the window 401 shown in FIG. 6 on the screen of LCD 15. When the user operates the input device 340, and the OK button 402 in the window 401 is pressed, the message display module 332 passes the process to the capture image storing module 333. When the user operates the input device 340, and the check box in the window 401 is checked, the message display module 332 passes the process to the capture image storing module 333 without displaying the window 401. The message display module 332 records a value indicating whether or not to display the window 401, in a flag 332A. The message display module 332 enables the value of the flag 332A when the window is displayed, and disenables the value of the flag 332A when the window is not displayed.

The capture image storing module 333 converts the image data generated by the capture image generation module 331 into an image file having a predetermined image format (e.g., JPEG), and stores the converted image file 121A in the hard disc drive 121. The capture image storing module 333 names the image file 121A as “yyyymmdd_hhmmss.jpg”. The “yyyy” indicates the year of generation of the image file 121A, “mm” indicates the month of generation of the image file 121A, “dd” indicates the day of generation of the image file 121A, “hh” indicates the hour of generation of the image file 121A, “mm” indicates the minute of generation of the image file 121A, and “ss” indicates the second of generation of the image file 121A. The capture image storing module 333 stores the image file 121A in a place “C:\Users\<user name>\AppData\Local\Temp” (a temporary folder), for example. The capture image storing module 333 registers the path to the image file 121A in the transmission tray 322.

When the authentication application program 203 notifies that communication with an external device is possible, the transmission control module 325 of the transmission tray application program 204 transmits the image file 121A indicated by the path registered in the transmission tray 322 to an external device by using the wireless proximity communication device 123, under the control of the device control module 303. During the transmission, the transmission control module 325 displays the window 411 shown in FIG. 7 on the screen of LCD 15. The window 411 has a progress bar 412, and a cancel button 413. The progress bar 412 indicates the progress of data transmission by black squares. If the user operates the input device 330, and presses the cancel button 413 during data transmission, the transmission control module 325 stops data transmission.

If the possibility of communication with an external device is not notified within a certain period of time after start of the transmission tray application program 204, the transmission tray application program 204 displays the window 421 shown in FIG. 8 on the screen of LCD 15. When the OK button 422 is pressed, the transmission control module 325 waits for a notice of possibility of communication with an external device for a certain period of time. When the cancel button 423 is pressed, the transmission control module 325 deletes all data indicating the path registered in the transmission tray 322, and deletes the image file 121A from the hard disc drive 121. When the communication with an external device is interrupted for a certain period of time during transmission, the window 421 is displayed.

In the above description, the start time of the transmission tray application program 204 is regarded as a reference time, and the window 421 is displayed when the possibility of communication with an external device is not informed within a certain period of time. However, the reference time is not limited to the start time of the transmission tray application program. For example, the reference time may be the fact that data indicating a path is registered in the transmission tray. Further, the reference time may be the time of data indicating a path stored in the transmission tray (e.g., the time of generation of an image file). The reference time may be selected from any time after depression of the screen capture button 224A.

When the transmission tray application program is started by regarding a path as an argument, after data is transmitted, the transmission control module 325 deletes the data indicating the path registered in the transmission tray 322, and deletes the image file 121A from the hard disc drive 121.

The transmission tray application program 204 is not an application program specialized to transmit a captured image file. When the transmission tray button 223A in the gadget 220A shown in FIG. 4A is pressed, the wireless proximity communication gadget application program 202 starts the transmission tray application program 204 without specifying the option (−c). After the transmission tray application program 204 is started, an image file selected by the user can be transmitted to an external device.

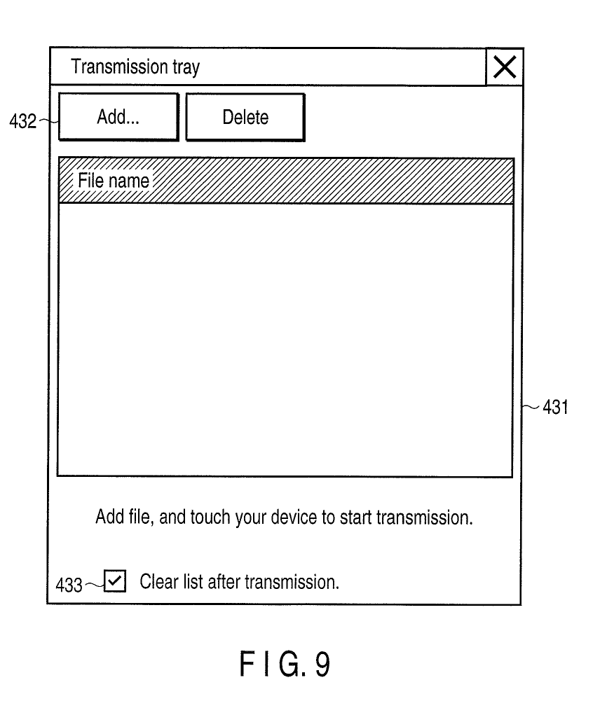

When the transmission tray application program 204 is started without specifying the option (−c), the window 431 shown in FIG. 9 is displayed on the screen of LCD 15. By using a file dialog displayed by depression of the Add button in the window, or by drag-and-drop of an icon indicating a file into the window 431, the user can select a file to be transmitted to an external device.

When the user operates the input device 330, and changes checking of the checkbox “Clear the list after transmission”, the flag management module 323 changes the value of the flag 324 according to the change. For example, the value of the flag 324 is enabled when the checkbox 433 is marked, and disabled when the checkbox 433 is not marked.

When the transmission tray application program 204 is started without regarding a path as an argument, and all data is transmitted based on the data registered in the transmission tray 322 indicating a path, all data indicating the path registered in the transmission tray 322 is deleted, when the value of the flag 324 is enabled. When all data is transmitted based on the data registered in the transmission tray 322 indicating a path, the data indicating the path registered in the transmission tray 322 is left, when the value of the flag 324 is disabled.

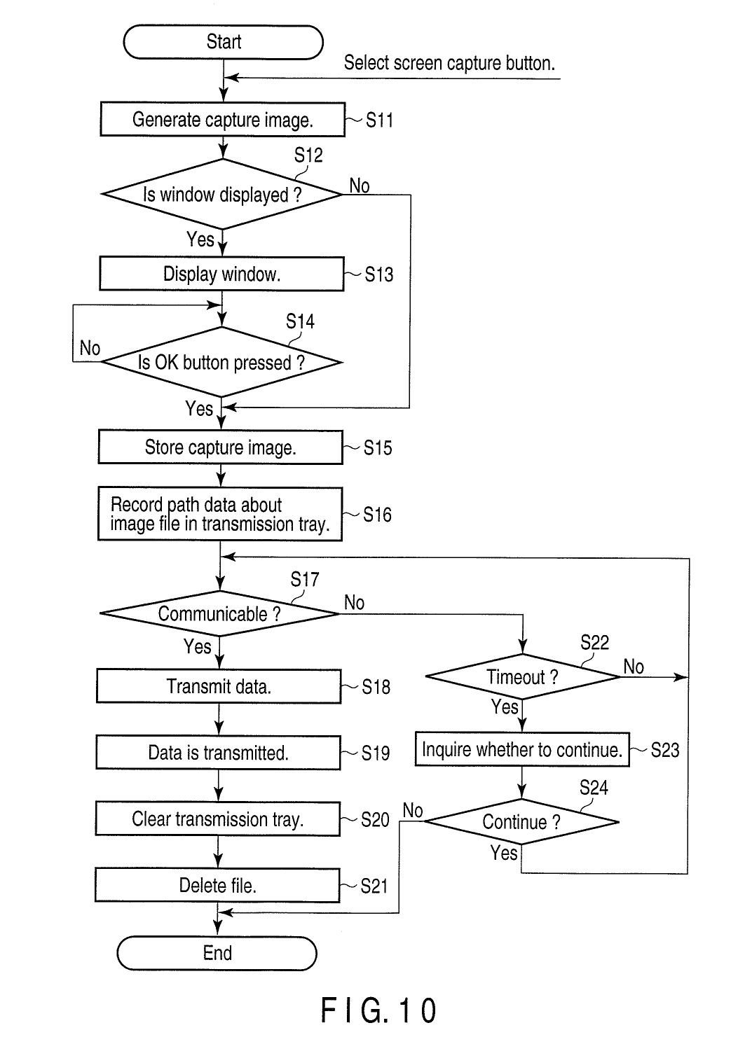

Processing executed by the transmission tray application program 204 will be explained with reference to the flowchart of FIG. 10.

First, when the data indicating that the screen capture button 224A is pressed in response to the user's operation of the input device 340, the capture image generation module 331 captures an image displayed on the screen of LCD 15, and generates image data corresponding to the captured image (block S11).

The message display module 332 refers to the value of the flag 332A, and determines whether the value is adequate to display the window 401 shown in FIG. 6 (block S12). When the value of the flag 332A is enabled and adequate to display the window (Yes in block S12), the message display module 332 executes a process to display the window 401 shown in FIG. 6 on the screen of LCD 15 (block D13). Then, the message display module determines whether the data indicating depression of the OK button 402 is entered in response to the user's operation of the input device 340 (block S14).

When the OK button 402 is pressed (Yes in block S14), or when the value of the flag 332A is disabled and not adequate to display the window 401 (No in block S12), the transmission tray start module 333 passes the process to the capture image storing module 333.

The capture image storing module 333 converts image data to an image file having a predetermined image format, and stores the converted image file 121A in the hard disc drive 121 (block S15). The capture image storing module 333 records the path to the image file 121A in the transmission tray 322.

When the data indicating a path to the image file 121A is recorded in the transmission tray 322, the transmission control module 325 periodically checks whether wireless proximity communication with an external device is possible (block S17). When the wireless proximity communication is impossible (No in block S17), the transmission control module 325 determines whether a certain period of time (e.g., 30 seconds) has passed after start of the transmission tray application program 204 (block S22). When a certain period of time has not passed (No in block S22), block S17 is resumed. When a certain period of time has passed (Yes in block S22), the transmission control module 325 displays the window 421 shown in FIG. 8 to ask the user whether to continue the transmission of a screen capture image (block S23).

When one of the OK button 422 and Cancel button 423 is pressed, the transmission control module 325 determines whether to continue the transmission (block S24). When the transmission is not continued (No in block S24), the transmission of a capture image is stopped. After the transmission is stopped, the transmission control module 325 deletes the data indicating the path stored in the transmission tray, and deletes the image file 121A stored in the hard disc drive 121. The flag management module 323 resets the value of the flag 324 to the original value. When the transmission is continued (Yes in block S24), block S17 is resumed.

When wireless proximity communication is determined to be possible in block S17 (Yes in block S17), the transmission control module 325 transmits the image file 121A indicated by the data indicating the path recorded in the transmission tray 322, to an external device by wireless proximity communication using the wireless proximity communication device 123, under the control of the driver 201A (block S18). After transmitting the image file 121A (block S19), the transmission control module 325 deletes the data indicating the path stored in the transmission tray 322 (block S20), and deletes the image file 121A from the hard disc drive 121 (block S21).

Next, an explanation will be given of the communication control driver 201A related to the control of wireless proximity communication and the authentication application program 203. First, the communication control driver 201A is explained.

The communication control driver 201A is operated in the operating system 201. The communication control driver 201A is a driver for controlling the wireless proximity communication device 123. The communication control driver 201A comprises a connection control module 301, a connection notify module 302, and a device control module 303.

The connection control module 301 controls a connection between the wireless proximity communication device 123 and an external device. When the wireless communication device 123 is enabled to communicate with an external device, a connection request signal and a response signal to the connection request signal are transferred between the wireless proximity communication device 123 and external device. In other words, in wireless proximity communication, one of two devices transmits a connection request signal, and the other device detects the connection request signal at predetermined time intervals. When the other device detects the connection request signal transmitted from one of the devices, a wireless connection is established between these two devices. When a wireless connection is established, device identification data such as a vender name, a device name, and an ID are exchanged between the devices.

When a wireless connection is established between two devices, the connection notify module 302 notifies the authentication application program 203 of the establishment of wireless connection. The connection notify module 302 informs the authentication application program 203 of the data to identify the connected external device, such as a vender name, a device name, and an ID.

The device control module 303 controls the wireless proximity communication device 123, and transmits a file and holder to an external device.

The authentication application program 203 comprises an authentication module 311, a device management module 312, and communication permitted device data 313. The communication permitted device data 313 stores data about devices permitted to make wireless proximity communication with a computer. The device identifying data consists of a vender name, a device name, and an ID.

The authentication module 311 determines whether a connected external device is a device permitted to make wireless communication. The authentication module 311 checks whether the vender name, device name and ID notified by the connection notify module 302 of the communication control driver 210A are stored in the communication permitted device data 313, and determines whether the connected external device is permitted to make wireless communication.

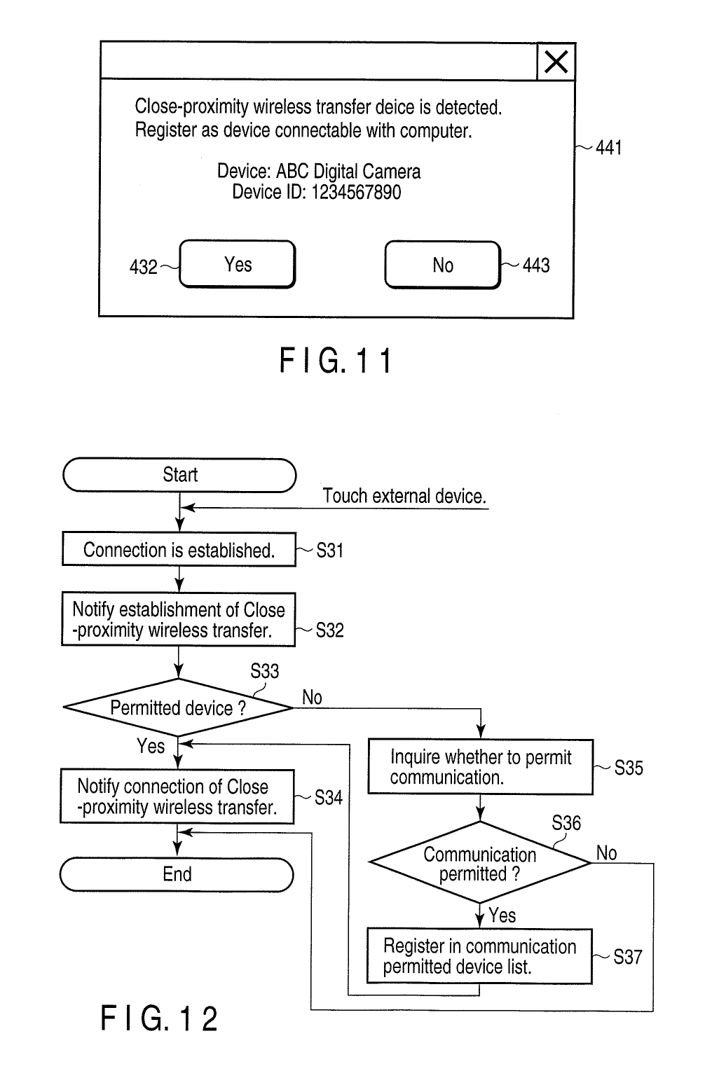

If the connected device is not permitted to make wireless communication, the authentication module 311 notifies the device management module 312 that a connection is established with a device which is not registered in the communication permitted device data 313. The device management module 312 displays the window 441 shown in FIG. 11 on the screen of LCD 15, and asks the user whether to register the connected device as a device permitted to make wireless communication. When the Yes button 432 is selected by the user, the device management module 312 registers the vender ID, device name and ID of the connected external device in the communication permitted device data 313. Then, the device management module 312 notifies the authentication module 311 that the connected external device has been registered in the communication permitted device data 313.

If the No button 443 is selected, the device management module 312 terminates the processing. In this case, the data identifying the connected device (e.g., a vender name, a device name, and an ID) may be registered in an unauthorized device list. This eliminates the inquiry to the user when the device registered in the unauthorized list is reconnected.

When an external device permitted to make wireless communication is connected, the authentication module 311 notifies the transmission tray application program 204 that the connected external device can communicate with a computer. After receiving the notice, the transmission tray application program 204 starts transmission of the image file 121A.

Next, an explanation will be given of a process from touching an external device to notifying the transmission tray application program 204 of the possibility of communication with the external device, which is executed by the communication control driver 201A and authentication application program 203, with reference to the flowchart of FIG. 12.

When the antenna 30 of the main unit is touched by an external device having a function of wireless proximity communication, the wireless proximity communication device 123 notifies the communication control driver 201A of the presence of the external device. The connection control module 301 of the communication control driver 201A controls the wireless proximity communication device 123, and establishes wireless proximity communication with the external device (block S31). During the process of establishing wireless proximity communication, the connection control module 301 obtains data to identify an external device such as a vender name, a device name, and an ID, to specify the connected external device.

When proximity wireless communication with an external device is established, the connection notify module 302 notifies the authentication application program 203 of the establishment of proximity wireless communication, and data to identify the connected external device (block S32).

The authentication module 311 of the authentication application program 203 compares the external device identifying data with the communication permitted device data 313, and determines whether wireless proximity communication with the connected external device is permitted (block S33).

When wireless proximity communication with the connected external device is not permitted (No in block S33), the device management module 312 displays the window to ask the user whether to permit wireless proximity communication with the connected external device (block S35), and determines whether the user selects wireless proximity communication with the device (block S36). When the user permits the wireless proximity communication with the device (Yes in block S36), the device management module 312 registers data to identify the external device in the communication permitted device data 313 (block S37). The device management module 312 notifies the authentication module 311 that the external device identifying data has been registered in the communication permitted device data 313. By this notice, the authentication module 311 determines that wireless proximity communication with the connected external device is permitted. If the user does not permit wireless proximity communication with the device, the authentication application program 203 terminates the processing (No in block S36).

When the authentication module 311 determines that wireless proximity communication with the device is permitted (Yes in S33), the authentication module 311 notifies the transmission tray application program 204 of the permission of wireless proximity communication with the external device (block S34).

As explained above, a capture image can be transferred to an external device by simple operations, for example, pressing the screen capture button 224A, and touching an external device.

A clipboard transmission button may be provided in the gadget. When the clipboard transmission button is pressed, a capture image may be converted into a file having a format preferable for the contents of the clipboard, and a converted file may be transmitted to an external device, as in the case of transmitting an image file.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a communication module configured to perform a close-proximity wireless transfer;
an input module;
a capturing module configured to capture an image displayed on a screen of a display according to an input from the input module;
a storing module configured to store an image file corresponding to the captured image in a storage;
a path register module configured to register, in a transmission tray, path data indicating a path of the image file stored in the storage; and
a transmission module configured to transmit the image file indicated by the path data registered in the transmission tray to an external device by the close-proximity wireless transfer when a connection is established between the communication module and the external device.

2. The information processing apparatus of claim 1, further comprising a deletion module configured to delete the path data registered in the transmission tray, after the image file is transmitted by the transmission module, and to delete the image file stored in the storage.

3. The information processing apparatus of claim 1, further comprising:
a determination module configured to determine whether a communication permitted device database comprises data associated with the external device, after the connection is established between the external device and the communication module, the communication permitted device database storing data indicating a communication permitted device; and
a notification module configured to notify the transmission module that the close-proximity wireless transfer with the external device is possible, when the determination module determines that the communication permitted device database comprises the data associated with the external device,
wherein the transmission module is configured to transmit the image file indicated by the path data registered in the transmission tray to the external device by the close-proximity wireless transfer when the notification module notifies that the close-proximity wireless transfer with the external device is possible.

4. The information processing apparatus of claim 3, further comprising:
an inquiry module configured to inquire of a user whether to permit the close-proximity wireless transfer with the external device, if the determination module determines that the communication permitted device database does not comprise the data associated with the external device; and
an external device registering module configured to register the data associated with the external device in the communication permitted device database, if the close-proximity wireless transfer with the external device is permitted by an input from the input module in response to the inquiry from the inquiry module,
wherein the determination module is configured to further permit the close-proximity wireless transfer with the external device, after the data associated with the external device data is registered in the communication permitted device database by the external device registering module.

5. The information processing apparatus of claim 1, further comprising:
a display module configured to display a window on the screen of the display to permit selection of a file from files stored in the storage according to an input from the input module,
wherein the path register module is configured to register, in the transmission tray, path data indicating a path of a image file selected according to the input from the input module while the window is being displayed.

6. A data transmission method using a transmission module configured to make close-proximity wireless transfer, the method comprising:
capturing an image displayed on a screen of a display according to an input from an input module;
storing an image file corresponding to the captured image in a storage;
registering, in a transmission tray, path data indicating a path of the image file stored in the storage; and
transmitting the image file indicated by the path data registered in the transmission tray, to an external device by the close-proximity wireless transfer, when a connection is established between the external device and the communication module.

7. The data transmission method of claim 6, further comprising:
deleting the path data registered in the transmission tray, after transmitting the image file, and deleting the image file stored in the storage.

8. The data transmission method of claim 6, further comprising:
determining whether a communication permitted device database comprises data associated with the external device, after the connection is established between the external device and the communication module,
wherein the image file is transmitted, when it is determined that the communication permitted device database comprises the data associated with the external device.

9. The data transmission method of claim 8, further comprising:
inquiring of a user whether to permit the close-proximity wireless transfer with the external device, if it is determined that the communication permitted device database does not comprise the data associated with the external device;
registering the data associated with the external device in the communication permitted device database, if the close-proximity wireless transfer is permitted by an input from the input module, in response to the inquiring,
wherein the image file is transmitted after the registering.

10. The data transmission method of claim 6, further comprising:
displaying a window on the screen of a display to permit selection of a file from files stored in the storage according to an input from the input module; and
registering, in the transmission tray, path data indicating a path of a file selected according to the input from the input module, while the window is being displayed.
